(19) United States
(12) Patent Application Publication
(10) Pub. No.: US 2009/0214070 A1
(43) Pub. Date: Aug. 27, 2009

(54) Headwear with detachable receiving part for portable audio device

(75) Inventors: Yong Moon Kwon, Seoul (KR); Ju Hee Kim, Seoul (KR); Il Dong Kim, Seoul (KR)

Correspondence Address: CHANG YEON JEONG, #790-4 Yeoksam-dong, kangnam-ku, Seoul, 135-080, KR

(73) Assignee: DADA Corp.

(21) Appl. No.: 12/071,607

(22) Filed: Feb. 25, 2008

(51) Int. Cl. H04R 1/10

(52) U.S. Cl. 381/376

(57) ABSTRACT

The present invention relates to a headwear with a detachable receiving part for a portable audio device, and more particularly, to a headwear with a detachable receiving part for a portable audio device which is capable of receiving a portable audio device and an earphone to facilitate listening to music as well as detaching the receiving part and putting it on user's arm to use it.

The headwear with receiving part for portable audio device according to the present invention includes a crown part which is a body of the headwear; a visor part attached to lower front part of the crown part; and a receiving band attached to rear and side peripheral portions of the crown part, wherein the receiving band is provided with an adjustment band and a portable audio device receiving part.

### BACKGROUND OF INVENTION

1. Field of Invention

The present invention relates to a headwear with a detachable receiving part for a portable audio device, and more particularly, to a headwear with a detachable receiving part for a portable audio device which is capable of receiving a portable audio device and an earphone to facilitate listening to music as well as detaching the receiving part and putting it on user's arm to use it.

2. Description of the Related Art

In recent, many people purchase portable audio devices such as MP3 players to listen to various sound outputs including music. Particularly, the listening to musing through the MP3 players has been already popularized and, according to this trend, portable audio devices having various shapes, designs and functions are manufactured to satisfy customers.

However, the users carrying the MP3 player and listening to music have insufficient space for carrying the MP3 player and the earphone cord of an earphone causes inconvenience in user's activity. Therefore, there is a need for an improvement.

### SUMMARY OF THE INVENTION

Accordingly, it is an aspect of the present invention to provide a headwear which allows a user to carry conveniently a portable audio device.

It is another aspect of the present invention to provide a headwear which allows a user to arrange an earphone cord connected with a portable audio device so as to be convenient for user's activity.

It is further another aspect of the present invention to provide a headwear which is capable of detaching a receiving band for receiving a portable audio device and putting it on user's arm.

The foregoing and/or other aspects of the present invention can be achieved by providing a headwear with detachable receiving part for portable audio device which includes a crown part which is a body of the headwear; a visor part attached to lower front part of the crown part; and a receiving band attached to rear and side peripheral portions of the crown part, wherein the receiving band is provided with an adjustment band and a portable audio device receiving part.

### BRIEF DESCRIPTION OF THE DRAWINGS

The above and/or other aspects and advantages of the prevent invention will become apparent and more readily appreciated from the following description of the exemplary embodiments, taken in conjunction with the accompany drawings, in which:

FIG. 1 is a perspective view illustrating a headwear according to an embodiment of the present invention;

FIG. 2 is a rear perspective view illustrating the headwear according to an embodiment of the present invention;

FIG. 3 is a left side view illustrating the headwear according to an embodiment of the present invention;

FIG. 4 is a development view illustrating a receiving band of the headwear according to an embodiment of the present invention;

FIG. 5 is a lower view illustrating the headwear according to an embodiment of the present invention; and

FIG. 6 is a view illustrating that the receiving band according to an embodiment of the present invention is put on user's arm.

### DETAILED DESCRIPTION OF THE ILLUSTRATIVE, NON-LIMITING EMBODIMENTS OF THE INVENTION

Reference will now be made in detail to the embodiments of the present invention, examples of which are illustrated in the accompanying drawings, wherein like reference numerals refer to like elements throughout. The embodiments are described below so as to explain the present invention by referring to the figures.

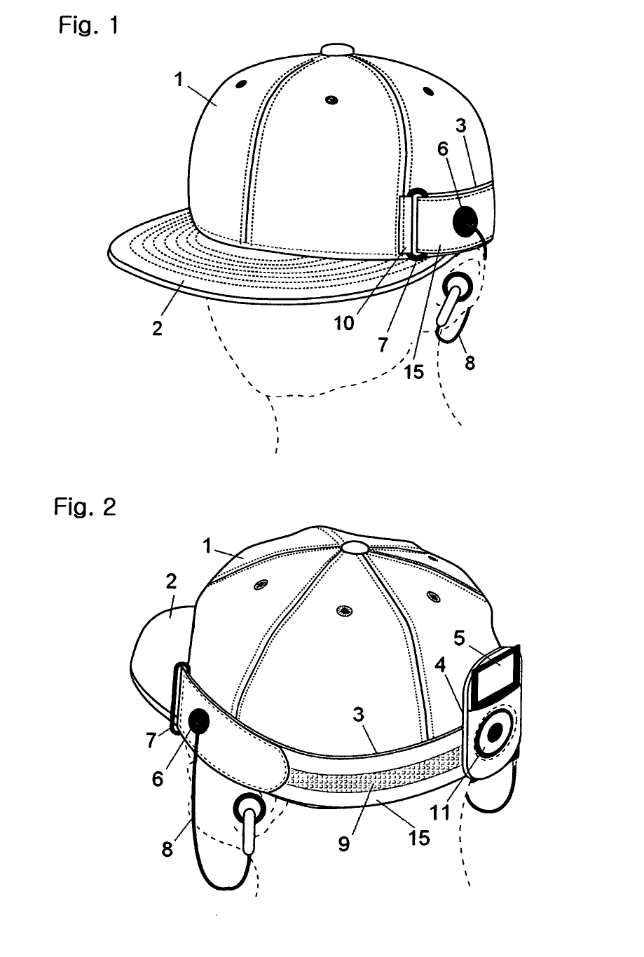

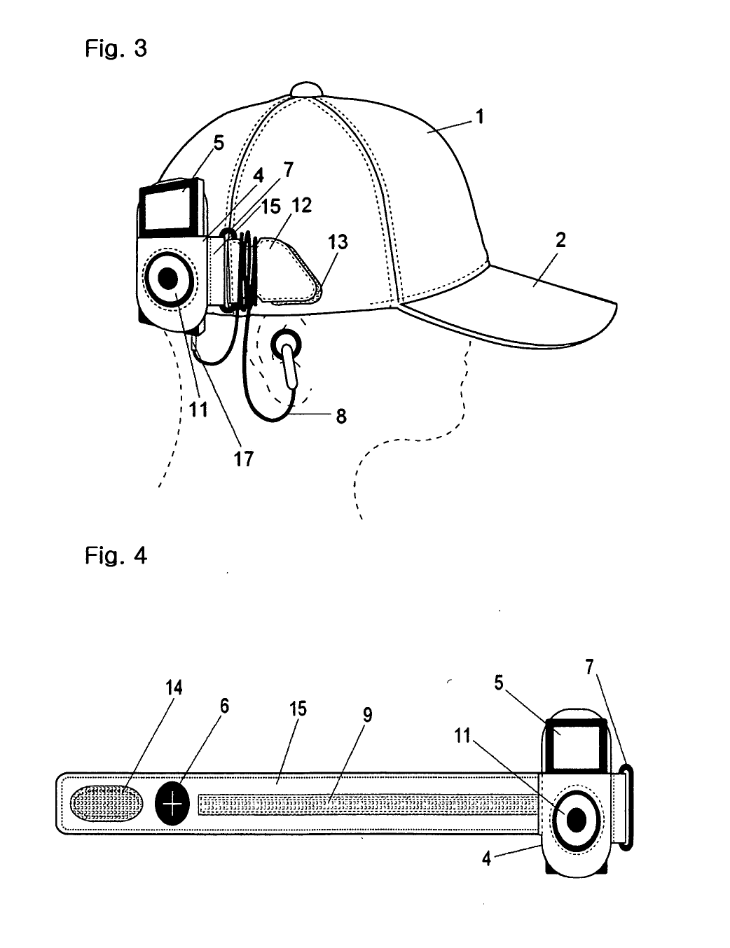

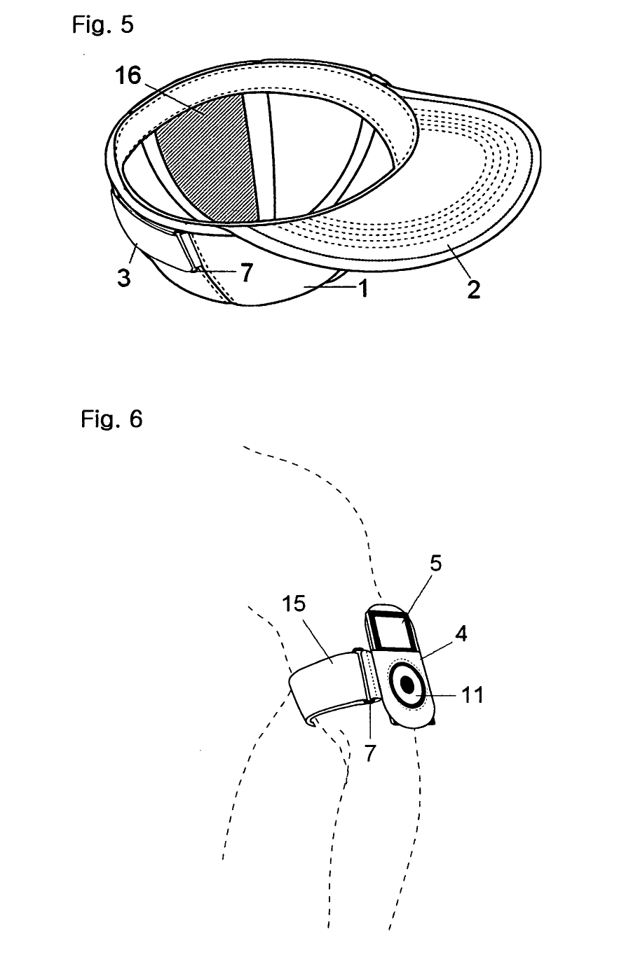

FIG. 1 is a perspective view illustrating a headwear according to an embodiment of the present invention; FIG. 2 is a rear perspective view illustrating the headwear according to an embodiment of the present invention; FIG. 3 is a left side view illustrating the headwear according to an embodiment of the present invention; FIG. 4 is a development view illustrating a receiving band of the headwear according to an embodiment of the present invention; FIG. 5 is a lower view illustrating the headwear according to an embodiment of the present invention; and FIG. 6 is a view illustrating that the receiving band according to an embodiment of the present invention is put on user's arm. As shown in FIGS. 1 through 6, a headwear with a detachable receiving part for a portable audio device according to an embodiment of the present invention includes a crown part 1 which is a body of the headwear and covers a user's head, a visor part 2 attached to lower front part of the crown part 1. A receiving band 3 for receiving a portable audio device is attached to rear and side lower peripheral portions of the crown part 1. The receiving band 3 includes a portable audio device receiving part 4 and an adjustment part 15. Coupling parts 10 and 12 are placed at both side lower surfaces of the crown part 1 so that the receiving band 3 can be coupled to and detached from the crown part 1. The right coupling part 10 has a connection ring 7 into which the adjustment band 15 can be inserted. The left coupling part 12 has one part affixed to the crown part 1 by sewing and the other part capable of being attached to and detached from a Velcro tape affixed to the crown part 1 so that it can be inserted into a connection ring 7 provided at the adjustment band 15. An earphone cord 8 may be wound onto the left coupling part 12. The adjustment band 15 of the receiving band 3 is provided with a Velcro tape 14 affixed to one end portion thereof, the connection ring 7 affixed to the other end portion thereof, inserting hole 6 for allowing the earphone cord to pass through the adjustment band 15 and a nappy fabric 9 affixed at a middle of the adjustment band 15 and attached to and detached from the Velcro tape 14 of the adjustment band 15. The audio receiving part 4 of the receiving band 3 is manufactured in a pocket type. A rear part of the audio device receiving part 4 forms a support having a size corresponding to the size of the portable audio device 5, an upper front part of the audio device receiving part 4 is opened so that the portable audio device 5 can be seen from the outside, and some portion of a lower front part of the audio device receiving part 4 is opened so that a plug 17 of the earphone cord 8 is inserted into a jack of the portable audio device 5 therethrough. An audio device controlling part 11, which is cut in a round shape so as to control sound of the portable audio device 5 from the outside, is formed at a middle of the portable audio device receiving part 4. An electromagnetic shielding fabric 16 is attached to an inside of the crown part 1 corresponding to the position where the portable audio device receiving part 3 is placed so as to prevent a user being influenced by electromagnetic wave from the portable audio device 5. The receiving band 3 is detachable from the coupling parts 10 and 12 placed at both sides of the crown part 1 and thus can be put on user's arm by winding the adjustment band 15 onto the user's arm.

As described above, a headwear with a detachable receiving part for a portable audio device according to the present invention includes a crown part which is a body of the headwear and a visor part attached to lower front part of the crown part, and is characterized in that a portable audio device receiving band for receiving a portable audio device is provided at a rear and side lower peripheral portions of the crown part, and the receiving band is provided with a portable audio device receiving part and an adjustment band, and the receiving band can be coupled to or detached from the crown part by coupling parts placed at both sides of side surface of the crown part. Therefore, a headwear with a detachable receiving part for a portable audio device according to the present invention has advantages that it is convenient for users to carry a portable audio device, an inconvenience of users due to the earphone cord connected with the portable audio device is removed and the receiving band can be detached from the headwear and then be put on the user's arm.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A headwear with detachable receiving part for portable audio device, comprising:
a crown part which is a body of the headwear;
a visor part attached to lower front part of the crown part; and
a receiving band attached to rear and side peripheral portions of the crown part,
wherein the receiving band is provided with an adjustment band and a portable audio device receiving part, coupling parts are placed at both side surfaces of the crown part to allow the receiving part to be attached to and detached from the crown part; the portable audio device receiving part is formed in a pocket type in which an upper part thereof is opened and some portion of a lower part thereof is opened so as to insert an earphone cord; and a fabric with Velcro tape and nap is provided at some portion of the adjustment part.

2. The headwear with detachable receiving part for portable audio device as set forth in claim 1, wherein an audio device controlling part, which is cut in a round shape so as to control sound of the portable audio device from the outside, is formed at a middle of the portable audio device receiving part.

3. The headwear with detachable receiving part for portable audio device as set forth in claim 1, wherein the adjustment band is provided with a connection ring affixed to one end portion thereof and a Velcro fastener affixed to the other end portion thereof.

4. The headwear with detachable receiving part for portable audio device as set forth in claim 1, wherein the coupling parts are provided with a connection ring affixed to one part thereof and a Velcro fastener affixed to other part thereof, the Velcro fastener being insertable into the connection ring of the adjustment band.

5. The headwear with detachable receiving part for portable audio device as set forth in claim 1, wherein an inserting hole for allowing the earphone cord to pass through the adjustment band is provided at some portion of the adjustment band.

6. The headwear with detachable receiving part for portable audio device as set forth in claim 1, wherein an electromagnetic shielding fabric is attached to an inside of the crown part corresponding to the position where the portable audio device receiving part is placed.
